(19) United States
(12) Patent Application Publication
(10) Pub. No.: US 2013/0060599 A1
(43) Pub. Date: Mar. 7, 2013

(54) People Risk Portal

(71) Applicants: Pang Jinfeng, Botannia (SG); Richard G. Payne, Landridge Condominium (SG)

(72) Inventors: Pang Jinfeng, Botannia (SG); Richard G. Payne, Landridge Condominium (SG)

(73) Assignee: AON CONSULTING, INC., Chicago, IL (US)

(21) Appl. No.: 13/230,932

(22) Filed: Sep. 13, 2011

Related U.S. Application Data
(60) Provisional application No. 61/530,205, filed on Sep. 1, 2011.

(51) Int. Cl. G06Q 10/00

(52) U.S. Cl. 705/7.28

(57) ABSTRACT

A computer server hosts a web portal used to customize and display data associated with personnel factors affecting business at a particular geographic location. The data may be collected covering a number of human resource factors, such as personal income, age, crime rate, education, corruption, healthcare and others and may be used to analyze problems such as recruitment, training, retention, etc. A portal allows access to the data for an individual location as well as presenting side-by-side comparison of multiple locations. The portal further allows a user to apply a custom weight to each factor according to the needs of a particular business, such as high tech or consumer products, to allow more meaningful analysis of the location or locations.

### CROSS-REFERENCE TO RELATED APPLICATION

This application is a non-provisional of application Ser. No. 61/530,205 filed Sep. 1, 2011. The entire text of the priority application is incorporated herein by reference in its entirety.

### TECHNICAL FIELD

The subject matter herein is generally directed to analysis of business risk associated with human resources and more specifically to a portal for presentation of human resources risk data by geographic location.

### BACKGROUND

Numerous tools exist for measuring business and financial risk. Analysis of stock market performance and currency volatility can be used when analyzing financial risks. Government stability, current or pending armed conflicts, natural resources and access to ports can be examined for determining the economic environment of a particular city or region. These, however, may not be the only considerations when locating or expanding a business.

### SUMMARY

Organizations operating in different cities or different geographic regions face different levels of operational risk depending on human resource factors in each city or geographic region. Factors relating to a workforce population can be evaluated using consistent criteria and, as much as possible, objective data on a region-by-region basis. The resulting values may be combined directly to develop a single numerical evaluation that can be used to compare regions, for example, for the purpose of evaluating locating, expanding, or contracting a business operation in that region. The factors may also be weighted to provide a custom view of a region when one or more factors are more or less important for a particular business. For example, a manufacturing enterprise may not be as concerned with the supply of university-level engineering graduates as a software development company.

### BRIEF DESCRIPTION OF THE DRAWINGS

FIG. 1 is a block diagram showing an electronic device in the form of a computer supporting a People Risk Portal;

FIG. 2 is a block diagram of a system environment for delivering people risk data;

FIG. 3 is a flow chart representing a method of presenting data associated with people risk;

FIG. 4 illustrates an exemplary screen shot of user interface for displaying people risk data;

FIG. 5 illustrates another exemplary screen shot of user interface for displaying people risk data;

FIG. 6 illustrates a screen shot of a map used to select people risk data for a region; and

FIG. 7 illustrates a screen shot of a comparison table of geographic regions.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

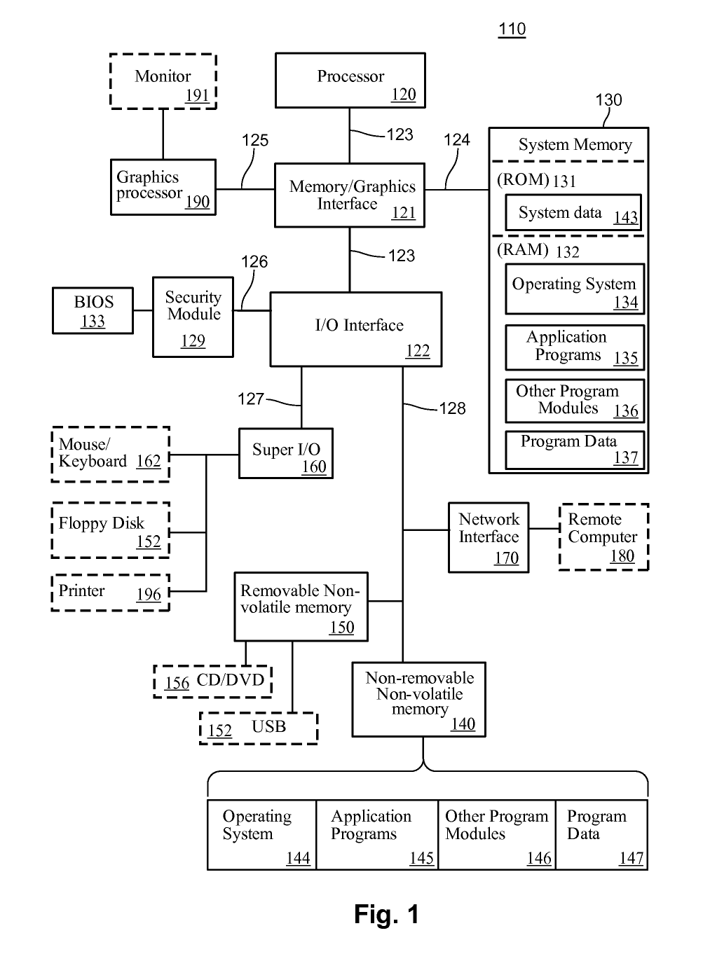

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121 and an I/O interface 122. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport™ architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer executable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices or other physical storage elements that physically embody electronic data and excludes any propagated media such as radio waves or modulated carrier signals.

The system memory 130 includes computer storage media in the form of volatile and/or nonvolatile memory such as read only memory (ROM) 131 and random access memory (RAM) 132. The system ROM 131 may contain permanent system data 143, such as computer-specific data that may be used as a seed for generating random numbers or nonces, for example, for use in authentication and authorization applications associated with single sign-on applications. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a bus 127, such as a low pin count (LPC) bus, in some embodiments. Various embodiments of the super I/O chip 160 are widely available in the commercial marketplace. In one embodiment, bus 128 may be a Peripheral Component Interconnect (PCI) bus.

The computer 110 may also include other removable/non-removable, volatile/nonvolatile computer storage media. By way of example only, FIG. 1 illustrates a hard disk drive 140 that reads from or writes to non-removable, nonvolatile magnetic media. The hard disk drive 140 may be a conventional hard disk drive.

Removable media, such as a universal serial bus (USB) memory 153, firewire (IEEE 1394), or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical communication ports to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet.

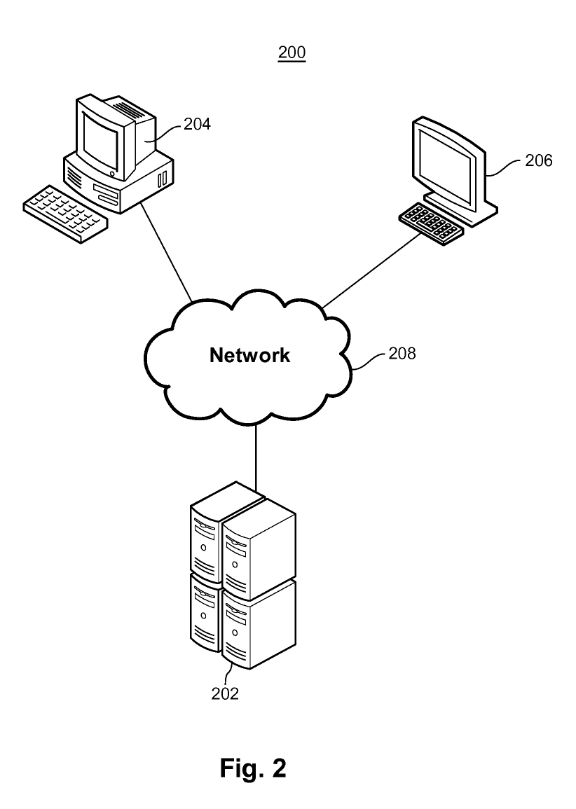

FIG. 2 is an illustration of a computing environment 200 supporting embodiments of a people risk portal. A computer or group of computers 202, may communicate with one or more client devices 204, 206 over a network 208. The network, in one embodiment, is the Internet. The computer or group of computers 202 may include separate data processing and storage computers as well as web servers (not individually depicted). Three and four tier architectures for serving web data may separate computers supporting page generation and network protocols from computers performing database and other background tasks. Such architectures are known and are not discussed further.

“People Risk,” is a term describing the contribution of human resource-related factors to the business climate of a particular geographic region. Other business climate factors for a region have long been recognized, factors such as transportation, access to natural resources, taxes, trade laws, tariffs, etc. However, the contribution of people risk to a geographic region has, at best, been approached in an ad-hoc manner and largely based on perception. Distribution of even this spotty information has also been ad-hoc and, if available at all, available for one area at a time. As used herein a geographic region may include a region, such as North America or Europe, Mideast, and Africa (EMEA) and may also include a country, a state or province, a metropolitan area, or a city.

A system and method in accordance with the current disclosure systematically rates a particular region on a number of measurable factors using data that is publicly available and consistently scored. Further, the disclosed system and method present the data to a user in a fashion that allows a user to both compare two or more regions side-by-side, and also to change the weighting of factors used to score a region to reflect a particular user's interests for the region or region(s).

For example, a company may wish to decide whether to expand manufacturing in a particular region or move to a different area. Along with other factors discussed above, such as, transportation costs and taxes, the ability to recruit and retain qualified workers and to re-train those workers if necessary as well as the government attitude toward diversity and corruption, as examples, should also be considered.

In an exemplary embodiment, five general areas or topics for people risk are defined: Demographics, Government Support, Education, Talent Development, and Employment Practices. Certainly, these are not the only general areas or topics that could be included but are representative areas of interest.

Table 1 illustrates an exemplary rating for a geographic region. Each general area has five measurements, rated on a scale of 1-10. Therefore, the lowest possible rating for each topic is 5 and the highest is 50. For the purpose of this example, a low score represents a more desirable characteristic and high score represents a less desirable characteristic. This choice is, however, arbitrary and the opposite scoring could be used just as easily.

Following this convention, if each general area or topic score ranges between 5 and 50, the sum of scores for the five topics will range between 25 and 250. The total of 25 subtopics used to develop the area scores and the total score provide enough breadth to cover a wide range of influences on a geographic region and also provide a way to re-weight the scores so that specific general areas or even specific subtopics can be emphasized or diminished according to a particular user's requirements. While there is no particular reason to use 25 subtopics, significantly fewer general areas or subtopics would necessarily require collapsing topics to the point of potentially blurring data and making re-weighting less meaningful. Conversely, significantly increasing the number of general areas and subtopics may become both unwieldy and make acquiring independent and fair-minded data difficult.

TABLE 1
GENERAL RISK AREAS
Overall Total: 74

| Risk Area | Rating |
|---|---|
| Demographics | 22 |
| Government Support | 16 |
| Education | 11 |
| Talent Development | 9 |
| Employment Practices | 16 |

Tables 2-6 illustrate subtopics with exemplary ratings for a particular region. For the purpose of illustration, the ratings in Tables 2-6 correspond to the summary provided in Table 1.

As discussed above, for this exemplary embodiment, each subtopic is afforded a rating of 1-10 based on data available for that subtopic. When a particular subtopic does not have an inherent 1-10 rating, a comparison of all regions is one way of scaling the data. For example, violence and crime rate may range from incidents/10,000 to incidents/hundred of population. The lowest crime rate may be set as a 1 and the highest crime rate set as a 10. Other crime rates can be scaled linearly between the low and high to arrive at an objective, repeatable rating using publicly available violence and crime statistics.

Note that some evaluations below deal with sensitive issues related to discrimination and/or personnel downsizing. While business decisions affecting employment can have a significant impact on a local economy, questions related to layoffs and downsizing are necessary to provide a complete picture of people risk in a geographic region. None of the evaluation criteria are intended to condone or promote unscrupulous business practices.

Table 2 illustrates 5 possible subtopics in the general area of demographics. The population size subtopic ranks an area's population and the availability of workers in an area. The emigration/immigration subtopic addresses whether there is a talent drain or influx. Personal income rates the region's wages, where a higher income is designated as a positive factor, at least partially in view of its relationship to other wage-earning factors.

Aging population is a subtopic that rates the population near or above retirement age. A higher percentage may indicate the loss to the workforce of experienced personnel as they reach retirement age and, as such, would be rated as a negative factor, that is, a higher percentage of aging population reduces a region's attractiveness. Violence and crime, as may be expected, are viewed as negative factors. Higher violence and crime reduce the attractiveness as an area in which to locate or expand a business.

TABLE 2
DEMOGRAPHICS RISK AREAS
Demographics
Demographics Total: 22

| Risk Factor | Rating |
|---|---|
| 1. Population Size | 4 |
| What is the population in the metropolitan area? | |
| 2. Immigration/Emigration | 2 |
| How does mobility and migration influence the local supply | |
| of human resources? | |
| 3. Personal Income | 1 |
| What is the GDP per capita (current prices in US$)? | |
| 4. Aging Population | 8 |
| What is the percentage of the population above the age of 60? | |
| 5. Violence & Crime Rate | 7 |
| How widespread is the incidence of violence and crime? | |

Exemplary questions and associated point values used to rate each factor may include:

1. What is the population in the metropolitan area?
2 no less than 15 million but less than 20 million
4 no less than 7 million but less than 10 million
6 no less than 4 million but less than 5 million
7 no less than 2 million but less than 3 million
10 less than 1.5 million
2. How does mobility and migration influence the local supply of human resources?
2 Both the inflows of skilled professional talents and labor forces supersede the outflows, which results in a net gain of both levels of human resources.
4 A temporary balance exists for skilled professional talents' inflow and outflow while the inflow of labor forces still supersede its outflow.
6 Skilled professional talents' outflow starts to outsize its inflow while a balance between inflow and outflow of labor forces is stricken.
8 Skilled professional talents' outflow starts to outsize its inflow while same imbalance starts to take place for labor forces as well.
10 Both the outflows of skilled professional talents and labor forces supersede the inflows drastically, which results in a large net loss in both levels of human resource.
3. What is the GDP per capita?
2 no less than USD20,000 but less than USD30,000.
4 no less than USD10,00 but less than USD15,000.
6 no less than USD5,000 but less than USD7,000.
8 no less than USD1,000 but less than USD3,000.
10 less than USD600.
4. What is the percentage of the population above the age of 60?
2 no less than 5% but less than 7.5%.
4 no less than 10% but less than 12.5%.
6 no less than 15% but less than 17.5%.
8 no less than 20% but less than 22.5%.
10 no less than 25%
5. How widespread is the incidence of violence and crime?
2 Composite index is between 0.75 and 0.9
4 Composite index is between 0.6 and 0.65
6 Composite index is between 0.45 and 0.55
8 Composite index is between 0.35 and 0.4
10 Composite index is below 0.25

The data used for generating the ratings in the demographics area may come from, for example, the World Economic Forum Global Competiveness Report, the UN Population Division, the World Bank, the International Monetary Fund, and the United Nations Office on Drugs and Crime.

Table 3 illustrates subtopics in the area of government support. Government support subtopics may include equal opportunity, such as the inability of one or more population groups to participate in economic activity. Other subtopics may include the flexibility of personnel costs and occupational health and safety. For example, government intervention in matters related to headcount and salaries are viewed negatively, while government support for safety, education, and certification are viewed positively. Another subtopic in government support may be government relations, that is, how confrontational are government agencies with respect to business practices. A last subtopic in this area may be government corruption. Corrupt government practices may drain resources from an enterprise and is viewed negatively.

TABLE 3
GOVERNMENT SUPPORT RISK AREAS
Government Support
Government Support total: 16

| Risk Factor | Rating |
|---|---|
| 6. Equal Opportunity | 3 |
| How do issues related to sex, religion or minority status impact | |
| business in your country? | |
| 7. Rigidity Of Personnel Costs | 4 |
| How flexible are personnel costs? | |
| 8. Occupational Health & Safety | 3 |
| What is the state of occupational health and safety practice? | |
| 9. Government Relations | 3 |
| How reasonable, non-confrontational and impartial are | |
| government agencies which are related to human resources? | |
| 10. Corruption | 3 |
| How prevalent is corruption? | |

Exemplary questions and associated point values used to rate each factor for government support may include:

6. How do issues related to sex, religion or minority status impact business in a country?
2 Laws prohibiting discrimination based on sex, religion or minority status are properly enforced and little or no discrimination exists in the workplace.
4 Laws prohibiting discrimination based on sex, religion or minority status are not fully enforced (or do not exist) but discrimination is not a major factor in the workplace.
6 Discrimination is prevalent in the workplace despite the laws prohibiting discrimination.
8 Laws prohibiting discrimination based on sex, religion or minority status are weak or nonexistent and discrimination is common in the workplace.
10 There are laws granting preferences based on sex, religion or minority status and discrimination is mandatory or prevalent.
7. How flexible are personnel costs
2 There are no legal restrictions against cutting compensation costs (e.g. salaries, bonuses, or benefits) or reducing headcount. Provided they are sensitive to employee concerns, companies can reduce personnel costs without significant long-term fall out on their business.
4 There are some legal restrictions on cutting specific areas of personnel costs (e.g. benefits, reducing headcount); however, companies still are able to make cutbacks without significant negative impact on their business provided they comply with government guidelines.
6 Companies can only reduce personnel cost or headcount through negotiations with employees or their union. The government oversees cutbacks to protect the interests of employees.
8 Government plays an important role in monitoring and regulating employers on their decisions regarding pay levels and headcount.
10 Companies are restricted from reducing headcount and salaries (or other forms of compensation) without the prior approval of the government.
8. What is the state of occupational health and safety practice?
2 Occupational health and safety are governed by a strictly enforced system of regulatory requirements supported by education, certification, auditing, consulting, and other resources.
4 Regulations on occupational health and safety are in place but enforcement and supporting resources are spotty and incomplete.
6 Regulations on occupational health and safety are gradually being developed and accidents and disputes periodically are a basis for concern.
8 Regulations on occupational health and safety are limited and accidents and disputes are common.
10 Regulations on occupational health and safety do not exist and accidents and disputes are a serious concern.
9. How reasonable, non-confrontational and impartial are government agencies which are related to human resources?
2 Government agencies are reasonable, non-confrontational and impartial to work with and outside assistance or counsel is rarely if ever required.
4 Government agencies are reasonable, non-confrontational and impartial to work with although outside assistance or counsel is sometimes required.
6 Government agencies can be a challenge to work with and outside assistance or counsel is often required.
8 Government agencies are often unreasonable, confrontational and partial to work with and outside assistance or counsel is frequently required.
10 Government agencies are very unreasonable, confrontational and partial to work with and outside assistance or counsel is required in all circumstances.
10. How prevalent is corruption as measured by Transparency International's Corruption Prevalence Index (CPI)?
2 CPI score no less than 7.75 but less than 8.5.
4 CPI score no less than 6.25 but less than 7.0.
6 CPI score no less than 4.75 but less than 5.5.
8 CPI score no less than 3.25 but less than 4.0.
10 CPI Score less than 2.5.

Data sources for the government support subtopic may include the Society for Human Resource Management (www.shrm.org), World Health Organization Data & Statistics, US Department of Labor—Bureau of Labor Statistics, and Transparency International Corruption Perception Index.

Table 4 illustrates subtopics in the area of education. Literacy rate directly corresponds to the general education level. Another subtopic, capacity of the education system, measures the ability to produce workers at the appropriate level of skill and training. Secondary school (e.g. high school) graduates and tertiary education (e.g. college) enrollment are also measures of the education level of the population and its capacity to add additional educated workers. Another exemplary subtopic is spending on education, that is, per capita education investment.

### Education

TABLE 4
EDUCATION RISK AREAS
Education Total: 11

| Risk Factor | Rating |
|---|---|
| 11. Literacy Rate | 1 |
| What is the adult literacy rate? | |
| 12. Capacity Of Education System | 3 |
| Does the education system have the capacity and capabilities | |
| to keep up with the demand for entry-level skilled technicians, | |
| engineers, and professionals? | |
| 13. Secondary School Graduates | 2 |
| What is the secondary school enrollment rate? | |
| 14. Tertiary Education Enrollment | 4 |
| What is the rate of enrolment at tertiary education institutions? | |
| 15. Spending On Education | 1 |
| What is the spending on education per capita? | |

Exemplary questions and associated point values for these subtopics may be based on the most correct answer for the following questions.

11. What is the adult literacy rate?
2 no less than 96% but less than 99% of the total population.
4 no less than 92% but less than 94% of the total population.
6 no less than 85% but less than 90% of the total population.
8 no less than 75% but less than 80% of the total population.
10 Below 70% of the total population.
12. Does the education system have the capacity and capabilities to keep up with the demand for entry-level skilled technicians, engineers, and professionals?
2 Entry-level skilled technicians, engineers, and professionals with the requisite education and skills level are widely available locally.
4 Entry-level skilled technicians, engineers, and professionals with the requisite education and skills level are available locally, but further training is sometimes necessary to bring them up to the required standards.
6 Entry-level skilled technicians, engineers, and professionals with the requisite education and skills level are in short supply and most new recruits require additional training.
8 A modest supply of entry-level skilled technicians, engineers, and professionals with the requisite education are available locally but they usually require significant further training.
10 Entry-level skilled technicians, engineers, and professionals with even limited education and skills level are unavailable.
13. What is the rate of enrolment at secondary schools?
2 no less than 95% but less than 100%
4 no less than 85% but less than 90%
6 no less than 75% but less than 80%
8 no less than 60% but less than 70%
10 less than 50%
14. What is the rate of enrolment at tertiary education institutions?
2 no less than 80% but less than 90%
4 no less than 60% but less than 70%
6 no less than 40% but less than 50%
8 no less than 20% but less than 30%
10 less than 10%
15. What is the spending on education per capita?
2 no less than USD2,500 but less than USD3,000
4 no less than USD1,500 but less than USD2,000
6 no less than USD500 but less than USD1,000
8 no less than USD80 but less than USD150
10 less than USD50

Exemplary sources for rating these subtopics can be found, for example, in The Economist magazine's Pocket World Figures, the World Economic Forum Global Competitiveness Report, World Bank indicators, the US Census Bureau. The rating of tertiary enrollment may be developed using the United Nations Educational, Scientific and Cultural Organization's (UNESCO's) Gross Tertiary Education Enrollment Rate, which is defined as the sum of all tertiary level students enrolled at the start of the school year, expressed as a percentage of the mid-year population in the 5 year age group after the official secondary school leaving age.

Table 5 illustrates subtopics in the area of talent development, relating to a region's ability to develop and maintain skilled workers from the local population. These subtopics may include the availability and quality of technical training. Government funded, high quality training can be very desirable, while employer supplied training as the only alternative may be a burden. Another exemplary subtopic may include the executive resource pool and their availability. Like quality of technical training, another factor impacting local talent is the quality of management training. The need to import skilled technical or management personnel can make it difficult to run an organization efficiently, if for no other reason than a lack of familiarity with the local culture. Another measure of the talent pool is the number of languages spoken. The ability of locally recruited personnel to speak the local language, plus English, plus perhaps another regional business language can be a great asset for an organization.

TABLE 5
TALENT DEVELOPMENT RISK AREAS
Talent Development
Talent Total: 9

| Risk Factor | Rating |
|---|---|
| 16. Availability Of Technical Training | 1 |
| Are external resources available to retrain and upgrade skills? | |
| 17. Quality Of Technical Training | 1 |
| What is the quality of external skill training resources? | |
| 18. Executive Recruitment | 1 |
| What is the availability of executive recruiting resources? | |
| 19. Quality Of Management Training | 1 |
| What is the quality of management and leadership development | |
| programs? | |
| 20. Languages Spoken | 5 |
| How multilingual is the workforce? | |

Exemplary questions and sample rating values related to talent development may include:

16. Are external resources available to retrain and upgrade skills?
2 Government and/or private sector maintain ample facilities and provides sufficient funding for any necessary retraining or upgrading of skills.
4 Government and/or private sector maintains some facilities and provides subsidized funding for selected retraining or upgrading of skills.
6 Facilities for retraining or upgrading of skills are available from private sector providers at commercial rates.
8 Facilities for retraining or upgrading of skills are scarce and expensive.
10 Training facilities are unavailable locally and employers must rely entirely on their own resources and facilities for training.
17. What is the quality of external skill training resources?
2 Skill training facilities and resources are world class and cover multiple disciplines with depth and specialization.
4 Skill training facilities and resources are adequate and broadly cover multiple disciplines with some depth and specialization.
6 Skill training facilities and resources are available for selected disciplines with limited depth and specialization.
8 Limited skill training facilities and resources are available and cover only selected disciplines with little depth and specialization.
10 Skill training facilities and resources are poor quality and coverage is extremely limited.
18. What is the availability of executive recruiting resources?
2 Numerous global and local firms provide comprehensive recruitment services across all industries.
4 Local firms and a few global firms provide most recruitment services across all industries.
6 Local firms provide some recruitment services across all industries.
8 A few local firms provide some recruitment services without industry specialization.
10 Recruitment resources and assistance are unavailable locally.
19. What is the quality of management and leadership development programs?
2 Facilities and resources for management and leadership development (e.g. MBAs) are world class and have a proven track record.
4 Facilities and resources for management and leadership development (e.g. MBAs) are good and are able to serve the local market.
6 Facilities and resources for management and leadership development (e.g. MBAs) are satisfactory but graduate relatively few qualified students.
8 Facilities and resources for management and leadership development (e.g. MBAs) are limited and/or emerging and the quality of graduates is unproven.
10 Facilities and resources for management and leadership development are unavailable locally.
20. How multilingual is the workforce?
2 Most professionals and managers can speak fluently in English plus a regional business languages (i.e. Arabic, Chinese, French, Spanish) in addition to their own native language.
4 Most professionals and managers can speak fluently in English plus a regional business languages (i.e. Arabic, Chinese, French, Spanish).
6 Most professionals and managers can speak fluently in English in addition to their own native language.
8 Most professionals and managers speak only their own native language, which is an international business language.
10 Most professionals and managers speak only their own native language, which is not an international business language.

Sources for answers to these questions may be found in a variety of sources, including the World Economic Forum Global Competitiveness Report, the QS World University Rankings, the Financial Times Global MBA Rankings, the IMD World Competitiveness Yearbook, and the US Census Bureau.

Table 6 illustrates five possible subtopics in the general area of employment practices. Government support and employment-related mandates may have a great impact on the ease of doing business in a region. Bias and favoritism is a measure of fair hiring and promotion policies, among others. Labor relations is an indicator of ease of doing business. Staff turnover in manufacturing jobs has a direct impact on recruiting and training costs. Healthcare and retirement benefits are also key areas of consideration with respect to business in a region. For example, government provided healthcare vs. employer provided healthcare can have a considerable impact on business planning. Similarly, government mandated and supervised retirement plans can take the uncertainty out of retirement cost planning, compared to open-ended employer-provided benefits.

TABLE 6
GOVERNMENT SUPPORT RISK AREAS
Employment Practices
Employment Total: 16

| Risk Factor | Rating |
|---|---|
| 21. Bias And Favoritism | 3 |
| How much bias and favoritism is practiced in hiring, promotion, | |
| development and firing? | |
| 22. Labor Relations | 2 |
| What is the environment for labor relations? | |
| 23. Staff Turnover | 5 |
| What is the annual voluntary staff turnover rate in | |
| manufacturing? | |
| 24. Healthcare Benefits | 2 |
| Do employers provide supplemental health care coverage to | |
| employees? | |
| 25. Retirement Benefits | 4 |
| What is the need for employer-provided retirement programs? | |

Exemplary questions and ratings for each subtopic related to government support may include:

21. How much bias and favoritism is practiced in hiring, promotion, development and firing?
2 Hiring, development, promotion and firing is entirely based on objective criteria of qualifications, experience and performance.
4 Hiring, development and firing is usually based on objective criteria of qualifications, experience and performance although there is occasionally incidences of favoritism.
6 Favoritism toward relatives, friends and community members often plays a part in hiring, promotion and firing alongside more objective criteria of education, experience and performance.
8 Favoritism toward relatives, friends and community members usually is the major determinant in hiring, promotion and firing.
10 Only relatives or friends are given favorable arrangement without regard to merit.
22. What is the environment for labor relations?
2 The labor relations environment is quite positive; work stoppages and worker grievances requiring outside intervention are rare.
4 The labor relations environment is generally positive; work stoppages and worker grievances requiring outside intervention occasionally occur.
6 The labor relations environment can sometimes be contentious; work stoppages and worker grievances sometimes require outside intervention.
8 The labor relations environment is often difficult; work stoppages and worker grievances requiring outside intervention are frequent.
10 The labor relations environment is extremely difficult; work stoppages and worker grievances requiring outside intervention are very common.
23. What is the annual voluntary staff turnover rate in manufacturing?

### 2 Between 5% and 6%.

### 4 Between 7% and 8%.

### 6 Between 9% and 10%.

### 8 Between 11% and 12%.

### 10 Above 13%.

24. Do employers provide supplemental health care coverage to employees?
2 The government-provided health care is excellent and available to all free of charge; supplementary health care benefits are either unnecessary or readily available and relatively inexpensive.
4 The government-provided health care is good and employer-funded health care benefits to supplement government programs are just an emerging practice.
6 The government-provided health care is insufficient to cover employee medical needs and employer-funded health care coverage is essential; supplementary health care benefits are common market practice.
8 Employees rely primarily on employer-provided health care benefits, which are quite expensive.
10 Publicly provided health care services are rudimentary and employees expect employers to provide and pay for the full cost of health care services.
25. What is the need for employer-provided retirement programs?
2 The government-mandated pension system is reliable and provides sufficient funds to cover expenses for employees after retirement. Employer-funded supplemental pension benefits are usually unnecessary.
4 The government-mandated pension system is reliable but provides insufficient funds to cover expenses for employees after retirement. Supplemental pension benefits are usually provided by employers according to clearly stated government regulation.
6 The government-mandated pension system is sometimes unreliable and payments cover only a small proportion of expenses for employees after retirement. Supplemental pension benefits are usually provided by employers within guidelines set by government regulation.
8 The government-mandated pension system is unreliable and insufficient. Supplemental pension benefits are provided by employers but the guidelines set by government regulation are unclear and open to interpretation.
10 There is no government-mandated pension system and an unregulated open market governs pension benefits, which creates huge uncertainty for employers with regard to their responsibility and liability.

Sources of data for these questions may include the World Economic Forum Global Competitiveness report, the World Bank Doing Business Report, the U.S. Social Security Administration report: Social Security Programs throughout the World, and OECD Pensions at a Glance.

Data sources for Tables 2-6 above are exemplary and may change over time as sources drop and new sources develop.

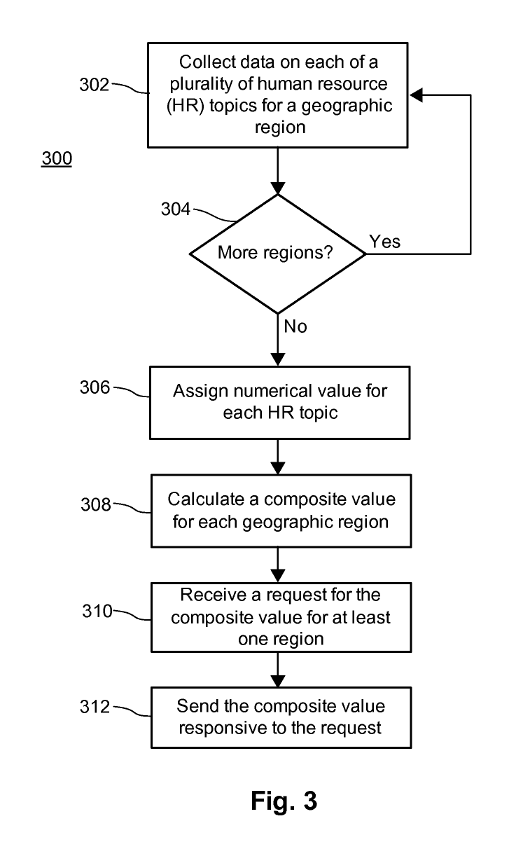

FIG. 3 is a flow chart representing a method of presenting data associated with people risk. The method may be executed on a computer, such as the computer 110 of FIG. 1, using computer executable code stored on a memory 130 or 140 of the computer 110. As is known, the computer-implementation of the method may include more than a single computer, such as an array of computers, a distributed computing environment, a server farm, cloud computing or other distributed computing techniques. Similarly, a web server used to support user interaction may also more than a single server and may include edge devices, server farms, cloud servers, etc.

A block 302 may collect data on each of a plurality of human resource topics for a respective geographic region of a plurality of geographic regions. The human resource topics may include those listed above in Tables 2-6, but that list should not be considered exhaustive. The geographic regions may include a single city, a metropolitan area, a county, state, province, country, or an identified region.

A block 304 may determine whether more regions are to be included. If so, the ‘yes’ branch from block 304 may be followed back to 302. Collecting of data for each of the plurality of human resource topics for each of the plurality of geographic regions may continue until the desired number of geographic regions has been researched. That is, the same data may be collected for each geographic region being researched. Collecting the same data for each region allows comparison of the regions using like data from like sources.

If the desired geographic regions have been covered, the ‘no’ branch may be followed to block 306. Block 306 may assign via the computer, a numerical value to each human resource topic (or subtopic) based on the data collected, as discussed above. For example, each human resource topic may be assigned a value on a 10 point scale, where a low value is more desirable and a higher value is less desirable, although the scale and direction of values can be varied.

A block 308 may calculate, via the computer, a composite value for each of the plurality of geographic regions using the numerical value for each of the plurality of human resource topics for its respective geographic region. Calculating the composite value may be as simple as adding the numerical values for each of the plurality of human resource topics or the values may be weighted, for example, if a particular characteristic is deemed more significant, especially by a specific user.

A block 310 may receive, via a web server operably connected to the computer, a request for the composite value corresponding to at least one geographic region. The request may include receiving, in the request, a weight for one or more human resource topics. In that case, the composite value may be re-calculated by applying the specified weight to the numerical value for its corresponding human resource topics. Referring to the tables above, a particular user may, for example, have an extensive in-house training program. Therefore, they may not be as interested in the ‘talent development’ general area and may weight that at 50%. Alternatively, that user may re-weight at the subtopic level and lower the rating of specific topics such as #12, “capacity of the education system” and #16, “availability of technical training” to achieve a similar result. Re-weighting may be accomplished via a drop down box of values, a slider bar, or other known techniques (not depicted). This flexibility to allow individual users to access, review, select, and re-weight general areas or individual subtopics is a departure from a simple paper report on competitiveness. This may be particularly true when selecting and comparing multiple geographic regions, such as Hong Kong vs. Manila or areas from much different cultures, such as Mumbai vs. Berlin or Chicago.

After compiling, and optionally re-weighting the data, a block 312 may send, via the web server operably connected to the computer, the composite value for at least one geographic region to a client device web browser, in response to the request. The data may be high level composite scores, such as Berlin 97 and Chicago 81. However, the data may also include ratings for subtopics so that specific areas can be compared. Alternatively, the data may be formatted into a map and may show specific regional or metropolitan area composite values, or may be color coded to indicate a broad comparison of overall people risk.

Downloading the data to the client device may include downloading executable code, such as Java or Javascript that allows selection of a particular geographic region causing the client device web browser to display details regarding a selected geographic region or regions.

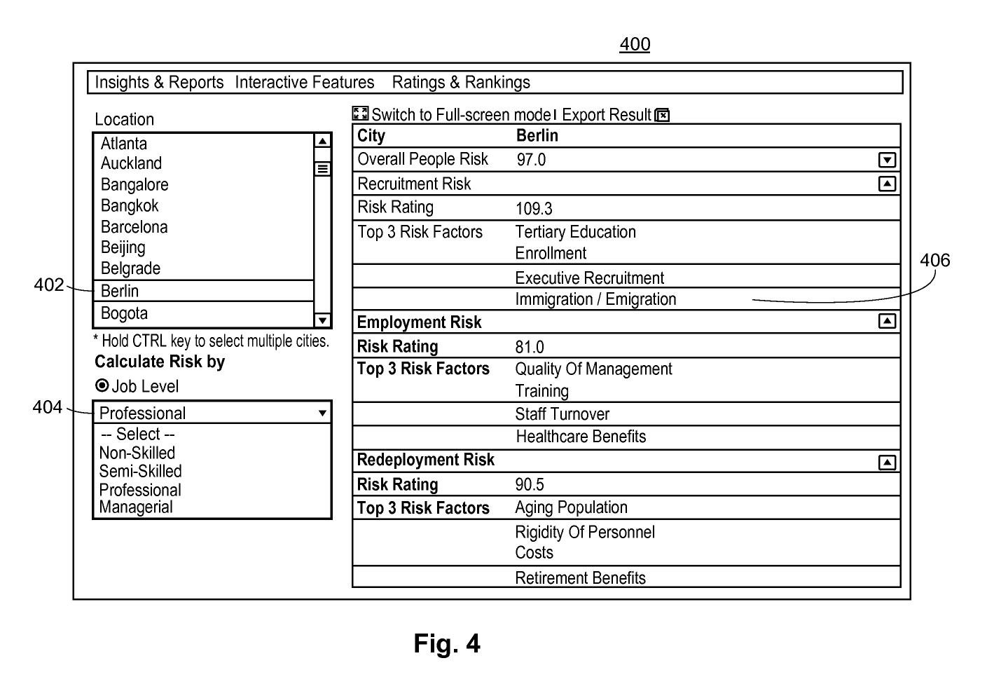

In an embodiment, calculating a composite value at block 308 may also include calculating a corollary risk rating characterizing a human resource factor as a combination of numerical factors for two or more human resource subtopics related to a particular job level. For example, when considering professional staffing in a particular city, recruitment risk may be characterized by the combination of ratings of tertiary education enrollment, executive recruitment, and immigration/emigration. Similarly, an employment risk for the same region for professional staff may be a compilation of scores for the quality of management training, staff turnover, and healthcare benefits. Other job levels may include, for example, non-skilled, semi-skilled, and managerial. See also FIG. 4 and related description below.

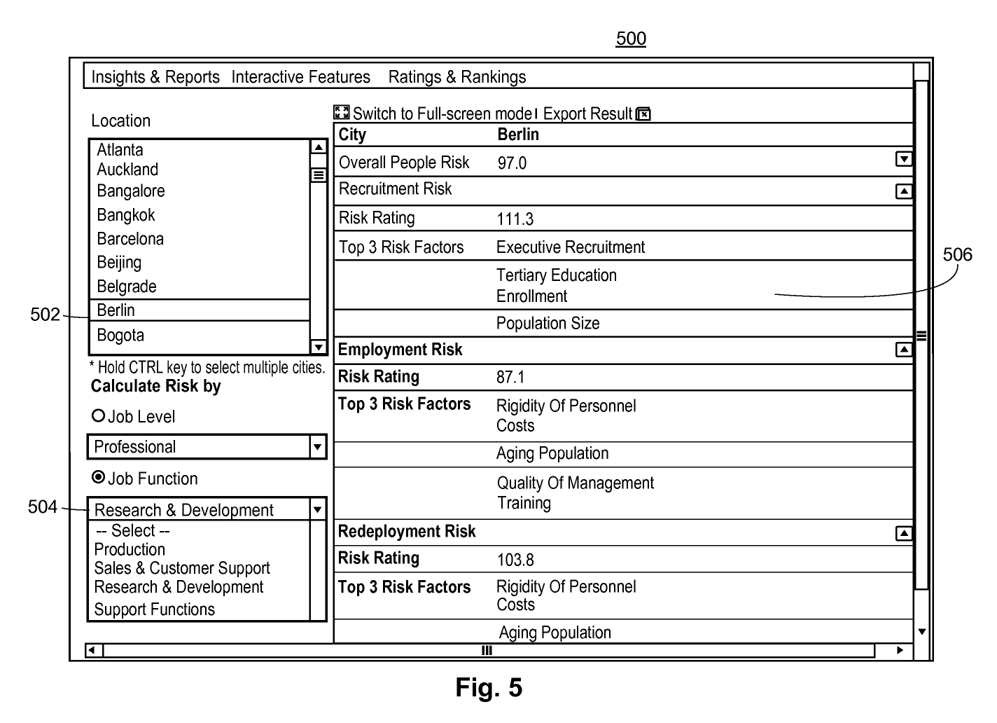

Characterizations can also be made by job function and may include production, sales/customer service, research and development, or support functions (such as information technology). See also FIG. 5 and related description below.

In order to limit access to such data, block 310 may include requiring access qualification data and may include registration information from a previously registered user or user data entered interactively that meets a criteria, such as having a qualified email address.

Referring to FIG. 1, a computer, such as computer 110 may include routines stored in memory such as memory 130 or 140 that may be executed on the processor 120. These routines may include a first routine that accepts a request from the client device for the people risk information and a second routine that sends data to a web browser at the client device providing an interactive map of selectable geographic locations with people risk data. The computer may also include a third routine that sends, responsive to an interactive call from the web browser at the client device, people risk data to populate a comparison table of two or more selected geographic regions.

The computer may also include additional routines that store the people risk information in areas including a demographics area, a government support area, an education area, a talent development area, and an employment practices area and that provide detailed people risk information for a geographic location responsive to a selection of the geographic location made on the interactive map at the client device.

FIG. 4 illustrates an exemplary screen shot 400 showing a window for city data selection. The city Berlin is shown selected form a location window 402 and a job level 404 is shown with the type of professional selected. A results area 406 shows an overall rating for the selected city as well as some of the top risk areas by subtopic.

FIG. 5 shows a screen shot 500 similar to that of FIG. 4. A location area 502 shows Berlin again selected and a job function selection 504 showing support functions selected. The results area 506 illustrates an exemplary rating for the selected city with an overall rating and different risk factors in view of the job function selection. Note the overall people risk rating is the same because the overall rating reflects all factors with a neutral weight.

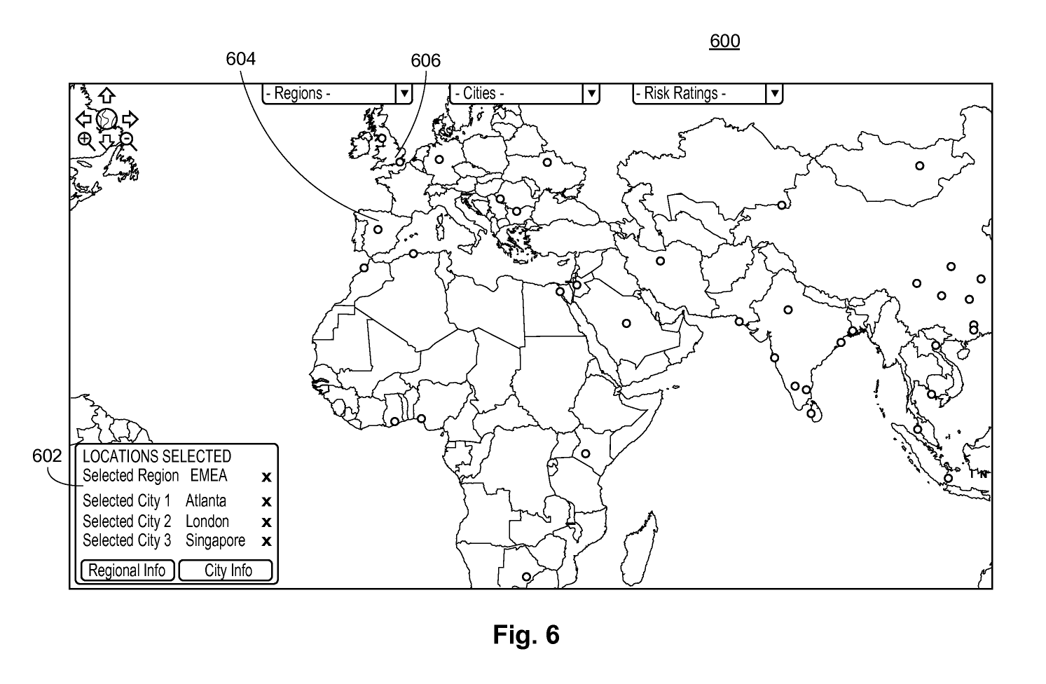

FIG. 6 illustrates a screen shot 600 of a portion of a global map in a window. The screen shot 600 includes a selection chart 602 showing that one region and 3 cities have been selected. The map shows the countries of the selected region highlighted 604. The screen shot 600 also shows individual cities, e.g., London 606, for which data is available.

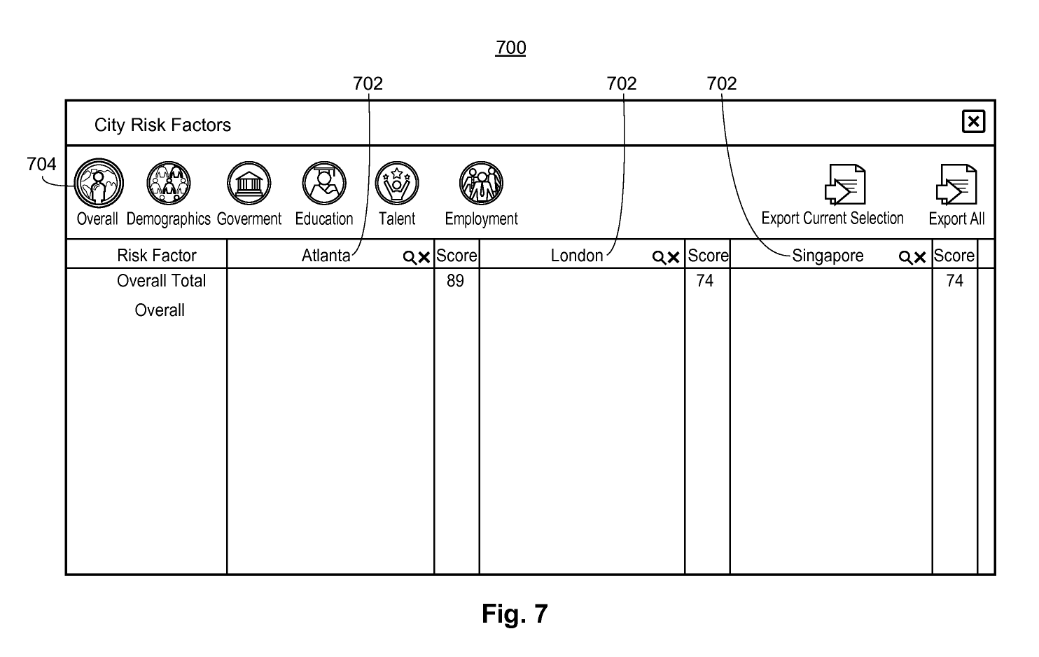

FIG. 7 illustrates a screen shot 700 of a comparison chart of the three selected cities from FIG. 6. The cities are listed in columns 702 showing individual scores. The data for the overall rating or general areas is available through respective icons 704.

The ability to research and display people risk comparison data provides a corporation or other entity a quick, configurable tool for decision making. The tool is consistent across regions and uses simple questions to assign values for interpreting subtopics related to each general area of personnel risk. Because access is web-based and interactive, the data is available in a flexible format to potential users worldwide, virtually instantaneously.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of presenting data associated with personnel risk executed on a computer using computer executable code stored on a memory of the computer, the method comprising:
collecting, at the computer, data on each of a plurality of human resource topics for a respective geographic region of a plurality of geographic regions;
repeating, at the computer, the collecting of data for each of the plurality of human resource topics for each of the plurality of geographic regions;
assigning, via the computer and using the data, a numerical value for each human resource topic for each of the plurality of geographic regions;
calculating, via the computer, a composite value for each of the plurality of geographic regions using the numerical value for each of the plurality of human resource topics for its respective geographic region; and
receiving, via a web server operably connected to the computer, a request for the composite value corresponding to at least one geographic region; and
sending, via the web server operably connected to the computer, the composite value for the at least one geographic region to a client device web browser responsive to the request.

2. The method of claim 1, wherein receiving the request for the composite value comprises:
receiving, in the request, a weight for one or more human resource topic; and
re-calculating, at the computer, the composite value by applying the weight to the numerical value corresponding to the one or more human resource topics.

3. The method of claim 1, wherein calculating the composite value comprises adding the numerical values for each of the plurality of human resource topics.

4. The method of claim 1, wherein assigning the numerical value comprises:
assigning each human resource topic a value on a 10 point scale.

5. The method of claim 1, further comprising:
sending, via the web server, a map to the client device web browser denoting each of the plurality of geographic regions having a respective composite value.

6. The method of claim 5, further comprising:
providing, via the web server, a computer-executable code to the client device web browser allowing selection of a particular geographic region that causes the client device web browser to display details regarding the selected particular geographic region.

7. The method of claim 5, further comprising:
calculating, at the computer, a risk rating characterizing a human resource factor as a combination of numerical factors for two or more human resource topics.

8. The method of claim 1, further comprising collecting at the computer data on each of the plurality of human resource topics in one of five areas: a demographics area, a government support area, an education area, a talent development area, and an employment practices area.

9. The method of claim 8, further comprising collecting at the computer data in the demographics area on at least two human resource topics from a group comprising: population size, immigration/emigration, personal income, aging population, or violence/crime rate.

10. The method of claim 8, further comprising collecting at the computer data in the government support area on at least two human resource topics from a group comprising: equal opportunity, rigidity of personnel costs, occupational health and safety, government relations, or corruption.

11. The method of claim 8, further comprising collecting at the computer data in the education area on at least two human resource topics from a group comprising: literacy rate, capacity of education system, secondary school graduates, tertiary education enrollment, or spending on education.

12. The method of claim 8, further comprising collecting at the computer data in the talent development area on at least two human resource topics from a group comprising: availability of technical training, quality of technical training, executive recruitment, quality of management training, or languages spoken.

13. The method of claim 8, further comprising collecting at the computer data in the employment practices area on at least two human resource topics from a group: bias/favoritism, labor relations, staff turnover, healthcare benefits, or retirement benefits.

14. A computer server that provides people risk information to a client device, the people risk information including data by geographic region and human resource topic, the computer server comprising:
a processor;
a communication network interface coupled to the processor;
a memory coupled to the processor;
a first routine, stored in the memory, to execute on the processor to accept a request from the client device for the people risk information;
a second routine, stored in the memory, to execute on the processor to send data to a web browser at the client device providing an interactive map of selectable geographic locations with people risk data; and
a third routine, stored in the memory, to execute on the processor to send, responsive to an interactive call from the web browser at the client device, people risk data to populate a comparison table of two or more selected geographic regions.

15. The computer server of claim 14, further comprising a fourth routine to execute on the processor to store the people risk information in areas including a demographics area, a government support area, an education area, a talent development area, and an employment practices area.

16. The computer server of claim 14, further comprising a fourth routine to execute on the processor to provide detailed people risk information for a geographic location responsive to a selection of the geographic location made on the interactive map.

17. A computer-implemented method, performed by a computer using executable code stored in a memory of the computer, to provide interactive data related to business-oriented people risk factors via a web service comprising:
receiving, at the computer via a web server, access qualification data from a participant at a client device;
sending, from the computer via the web server, data causing an initial page to be displayed, the initial page presenting a selection of an interactive map or a region-specific data selection;
generating, at the computer, people risk data associated with a plurality of geographic regions responsive to communication from the client device, the people risk data including a composite people risk value based on a numerical rating of human resource topics in at least two areas selected from a group comprising: demographics, government support, education, talent development, or employment practices
receiving, at the computer via the web server, a request the people risk data for at least one geographic region;
providing, at the computer via the web server, the people risk data associated with the people risk data for the at least one geographic region responsive to the request from the client device.

18. The method of claim 17, wherein the human resource topics comprise recruitment risk factors comprising: spending on education, capacity of education system, and immigration/emigration.

19. The method of claim 17, wherein the human resource topics comprise employment risk factors comprising: healthcare benefits and staff turnover.

20. The method of claim 17, wherein the human resource topics comprise redeployment risk factors comprising: retirement benefits and availability of technical training.
